(19) United States
(12) Patent Application Publication
(10) Pub. No.: US 2020/0191370 A1
(43) Pub. Date: Jun. 18, 2020

(54) LED STRIP WHICH COMPLY WITH HIGH VOLTAGE AC DRIVING POWER

(71) Applicant: LiliBrand LLC, Brooklyn, NY (US)

(72) Inventors: Ariel Shohat, Modin (IL); Ariel Meir, Brooklyn, NY (US)

(73) Assignee: LiliBrand LLC, Brooklyn, NY (US)

(21) Appl. No.: 16/717,883

(22) Filed: Dec. 17, 2019

Related U.S. Application Data
(60) Provisional application No. 62/915,604, filed on Oct. 15, 2019.
(60) Provisional application No. 62/780,545, filed on Dec. 17, 2018.

(51) Int. Cl. F21V 23/00; F21S 4/28

(52) U.S. Cl. CPC F21V 23/001; F21Y 2103/10; F21S 4/28

(57) ABSTRACT

Strip lighting systems that include a series of LEDs and which comply with AC driving power.

### CROSS-REFERENCE TO RELATED APPLICATIONS

This application claims priority to each of U.S. Provisional Application Ser. No. 62/780,545, filed Dec. 17, 2018 and U.S. Provisional Application Ser. No. 62/915,604, filed Oct. 15, 2019, both of which are incorporated herein by reference in their entireties.

### FIELD

The invention relates generally to lighting and, more particularly, to strip lighting systems that include a series of LEDs and which comply with AC driving power.

### BACKGROUND

Light emitting diodes (LEDs) are typically formed from a semiconductor material that is doped to create a p-n junction. The LEDs typically emit light in a narrow spectrum (e.g., a spectrum that is smaller 100 nanometers in size) that is dependent upon the bandgap energy of the semiconductor material that forms the p-n junction.

In some application, lighting systems may include one or more optical component that receives light emitted from an LED. For example, a lens is a type of optical component that may be used to receive light emitted from an LED and adjust one or more characteristics of the light.

### SUMMARY

Strip lighting systems that include a series of LEDs and which comply with AC driving power are described herein.

In one aspect, a strip lighting system is provided. The system comprises a tray and a circuit board disposed in the tray. One or more light emitting diodes (LEDs) are mounted to the circuit board. One or more wires are electrically connected to the circuit board and disposed at least in part within the tray. The system further comprises an elastomer in contact with the tray and encapsulating at least part of the circuit board and the one or more wires. The system is configured to be driven directly or indirectly by an AC power source of at least 60 Volts.

In some embodiments, the system further comprises a connector component electrically connected to the one or more wires. At least a portion of the connector component may not be encapsulated by the elastomer, in some cases.

In some embodiments, the system further comprises one or more lenses disposed over the one or more LEDs.

In some embodiments, the elastomer comprises silicone material.

In some embodiments, the tray comprises a divider that separates the tray into an upper section and a lower section. The circuit board and the one or more LEDs may be disposed within the upper section of the tray. The divider may comprise a base upon which the circuit board is positioned. The one or more wires may be disposed at least in part within the lower section of the tray.

In some embodiments, the one or more wires and/or the connector extend through an inlet port in the tray. The inlet port may be formed in an upper section of the tray. The one or more wires passes from the upper section of the tray to lower section of the tray via one or more apertures formed in the divider.

In some embodiments, the system comprises more than one strip lighting segment joined together.

In some embodiments, the lighting system is directly driven by an AC power source. For example, the voltage source may be a wall power socket.

In some embodiments, the lighting system is indirectly driven by an AC power source. The lighting system may be directly driven an LED driver electrically connected to the AC power source. In some embodiments, the LED driver is configured to convert the AC power to DC power. For example, the LED driver may be a rectifier power supply unit or a high voltage switched mode power supply (SMPS) unit.

Other aspects, embodiments and features will become apparent from the following non-limiting detailed description when considered in conjunction with the accompanying drawings, which are schematic and which are not intended to be drawn to scale. In the figures, each identical or nearly identical component that is illustrated in various figures typically is represented by a single numeral. For purposes of clarity, not every component is labeled in every figure, nor is every component of each embodiment shown where illustration is not necessary to allow those of ordinary skill in the art to understand the invention. In cases where the present specification and a document incorporated by reference include conflicting disclosure, the present specification shall control.

### BRIEF DESCRIPTION OF DRAWINGS

FIG. 1 shows a top view of a strip lighting system according to certain embodiments described herein.

FIG. 2 shows a cross-section of a strip lighting system according to certain embodiments described herein.

FIGS. 3A and 3B show wiring configurations used in connection with a strip lighting system according to certain embodiments described herein.

### DETAILED DESCRIPTION

Lighting systems are described herein. The lighting system may be implemented as a strip lighting system having a length (e.g., approximately six inches), a width that is less than the length (e.g., approximately one inch), and a height that is less than the width (e.g., approximately half an inch). As described further below, the lighting systems may be driven directly or indirectly by high voltage (e.g., 110 V, 220 V, etc.) alternating current (AC) power (e.g., supplied via a wall power socket). Embodiments of the lighting systems described herein may enable a number of advantages including the ability to connect the AC power source to the LED strip system on site, cutting and sealing the lighting strip for adjusting its length on site to fit the installation as well as the ability to use a long length strip by connecting several strip sections to one another, amongst other advantages. Moreover, the lighting systems may be designed to meet the requirements of UL 1598 standard as well as a polymeric enclosure structure that meets a UL94 5VA rating.

In some embodiments, the strip lighting system comprises a plurality of LEDs that are spaced along the length of the strip lighting systems (e.g., the LEDs may be spaced apart by approximately one inch). Strip lighting systems may have a construction similar to those described in U.S. Pat. Nos. 9,976,710 and 10,132,476 both of which are incorporated herein by reference in their entirety.

As described further below, the strip lighting system may comprise a tray, a circuit board disposed in the tray (e.g., disposed and/or mounted to a surface of the tray), an LED mounted to the circuit board, and an elastomer (e.g., silicone, rubber, etc.) encapsulating at least part of the circuit board and being in contact with the tray. One or more wires may run along at least a portion of the lighting strip (e.g., beneath the circuit board) and can electrically connect the circuit board(s) to an external power source. For example, at one end, the wires may be soldered to the circuit board and, at the opposite end, the wires may connect directly or indirectly to an AC power source. The AC power source may be a high voltage source of at least 60 Volts (e.g., 60 Volts-240 Volts), at least 110 Volts (e.g., 110 Volts-240 Volts) and the like. For example, the AC power source may provide standard household voltage such as 110 Volts, 115 Volts, 120 Volts, 220 Volts or 240 Volts. In embodiments which utilize direct connection, the wiring (and/or electrical connector which is connected to the wiring) may be directly connected to a wall port which supplies AC power. In embodiments which utilize indirect connection to an AC power source, the voltage source may be an LED driver power source (e.g., rectifier power supply unit, high voltage switched mode power supply (SMPS) unit) that converts the standard AC high voltage from the wall port to any high voltage output which may be either CV (constant voltage) or CC (constant current). In some of these embodiments, the LED driver power source may be a component external of the tray assembly; and, in other embodiments, the LED driver power source may be mounted on the PCB and encapsulated within the tray assembly. In other embodiments, the LED driver power source may be mounted within the tray and encapsulated within it.

In some embodiments, the strip lighting system may further comprise a lens assembly that is disposed above the LED and configured to change at least one characteristic of the light from the LED. The lens assembly may comprise at least one optical element such as a lens, a reflector, and/or a light scattering element. For example, the lens assembly may comprise only a lens. In another example, the lens assembly may comprise a lens and a reflector. The lens assembly may be attached to the strip lighting device via the circuit board (e.g., the lens assembly may be mounted to the circuit board) and/or the elastomer that at least partially encapsulates the circuit board (e.g., the elastomer may be in direct contact with at least part of the lens assembly).

As noted above, the lighting system may comprise an elastomer that at least partially encapsulates the circuit board. For example, the elastomer may be in contact with the circuit board and one or more components of the lens assembly such as the reflector. The elastomer may not be in contact with all of the components of the lens assembly. For example, the elastomer may not be in contact with the lens so as to provide a gap (e.g., an air gap) between the lens and the elastomer. The elastomer may protect the circuit board and/or electronic components mounted to the circuit board from the environment. Examples of suitable elastomers are described further below and include silicones and rubbers.

It should be appreciated that the embodiments described herein may be implemented in any of numerous ways. Examples of specific implementations are provided below for illustrative purposes only. It should be appreciated that these embodiments and the features/capabilities provided may be used individually, all together, or in any combination of two or more, as aspects of the technology described herein are not limited in this respect.

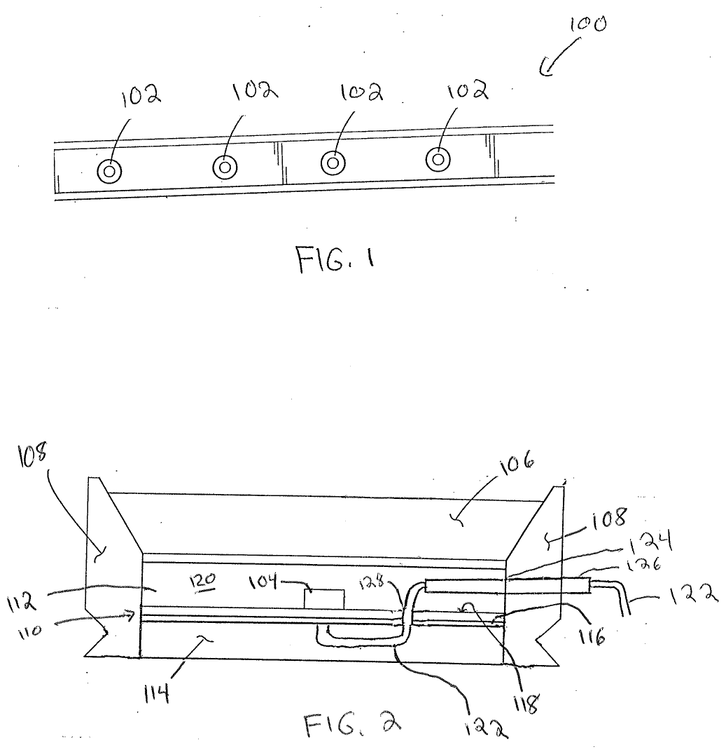

FIGS. 1 and 2 show top and cross-section views, respectively, of a lighting system 100 according to some embodiments. As shown, the lighting system 100 is constructed as a strip lighting system. The strip lighting system includes a plurality of LED assemblies 102 which are arranged along the length of the system.

The LED assemblies 102 include at least one (and, in some cases, more) LED 104. In general, the LEDs used in the systems may have any suitable design. For example, the LED may be a semiconductor device that is configured to emit light. The light emitted from the LED may have an angular CCT deviation such as a phosphor converted LED. As described further below, the LEDs may be mounted on a circuit board (e.g., PCB).

As noted above, in some embodiments and as shown in FIG. 2, the lighting system may optionally comprise a plurality of lens assemblies 106 disposed over the LEDs. The lens assemblies may each comprise at least one optical element such as a lens, a reflect, and/or a scattering element. The lens assemblies may change at least one characteristic of the light emitted from the LEDs. For example, the LEDs may be phosphor converted LEDs that emit light with an angular CCT deviation. In this example, the lens assemblies may receive light from the LED and make the color temperature of the light more uniform. Additionally (or alternatively), the lens assembly may adjust a light distribution pattern of the LED. For example, the lens assembly may create a circular beam of light or an oblong beam of light. Example implementations of the lens assembly 106 are described in detail in U.S. Patent Publication No. 2017/0261186, titled “LIGHTING SYSTEM WITH LENS ASSEMBLY,” published on Sep. 14, 2017, which is hereby incorporated herein by reference in its entirety.

It should be appreciated that the lens assemblies may be constructed from any of a variety of materials. For example, the lens assemblies may be constructed from one or more of the following materials: plastic (e.g., acrylic or polycarbonate), glass, and silicone. Further, the lens assemblies may be monolithic elements.

It should be appreciated that various alterations may be made to the lighting system 100 without departing from the scope of the present disclosure. For example, the lens assemblies 106 may be removed and, thereby, directly expose the LEDs under the lens assemblies 106. An example of such a lighting system without lens assemblies is described in U.S. Patent Publication No. 2016/0201861, titled “FLEXIBLE STRIP LIGHTING APPARATUS AND METHODS,” published on Jul. 14, 2016, which is hereby incorporated herein by reference in its entirety.

As shown in FIG. 2, the lighting system comprises a tray 108 with a divider 110 that separates the tray into an upper section 112 and a lower section 114. The divider may comprise a base layer 116 upon which the circuit board 118 may be positioned. The base layer may be comprised of similar material (e.g., silicone) which forms side walls of the upper section.

The tray, for example, may have a minimum thickness of at least 2.5 mm and, in some areas, greater thicknesses. The upper section of the tray may have dimensions designed to accommodate optical components such as lens assemblies. The lower section of the tray may, for example, have a rectangular cross-section, though other cross-sectional shapes are possible.

The tray (e.g., upper and/or lower sections) may comprise a silicone material. In some embodiments, the tray is formed primarily (e.g., greater than 50% by weight, greater than 70% by weight, greater than 90% by weight) or essentially entirely of silicone. In some embodiments, the tray may consist essentially of a silicone material. For example, an extrusion process may be used to manufacture the tray according to certain embodiments.

A series of LEDs 104 are mounted on the circuit board in the upper section of the tray at regular intervals along the length of the system. As described above, the lens assemblies may be positioned above each LED. Potting (i.e., encapsulating) material 120 may be added to fill remaining space in the upper section of the tray. Thereby, the potting material 120 may be in contact with the circuit board, sections of the tray, the LEDs and/or lens assemblies as well as other components. Thereby, the circuit board may be at least partially encapsulated with an elastomer. The potting material and/or the tray may be constructed from an elastomer such as silicone material. For example, both the potting material and the tray may comprise silicone. It should be appreciated that the potting material may have a different material composition than the tray. In general, the tray and potting material are selected and configured to enable the lighting system to meet with the UL94 5VA test procedure.

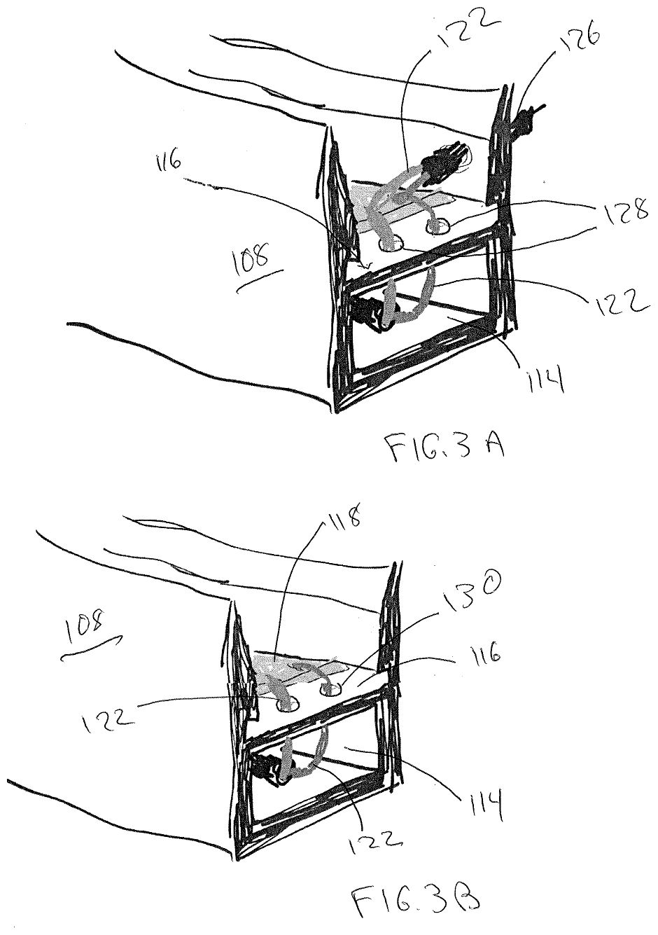

The lower section of the tray may house wiring 122 used to make electrical connections within the system. FIGS. 3A and 3B show wiring configurations that may be used according to certain embodiments. For example, the wiring may extend within the lower section of the tray beneath the circuit board along at least a portion of the length of the lighting strip. The wiring may supply power to the circuit board and, thus, the LEDs mounted on the circuit board. In some embodiments, multiple wires are utilized (e.g., ground wire, hot wire, etc.). In general, any type of wires that are suitable for use at the installation site may be used. The wiring may be connected to the circuit board. For example, wiring may be soldered to bond pads on the circuit board which are, in turn, electrically connected to the LEDs. During use, the wiring is electrically connected (directly or indirectly) to the AC power source. In some embodiments, the wiring may be connected to one or more electrical connector components. For example, the electrical components may facilitate connection of the wiring to the lighting system. Other embodiments may not utilize a separate electrical connector component.

Potting (i.e., encapsulating) material may be added to fill remaining space in the lower section of the tray. Thereby, the potting material may be in contact with the wiring, electrical connector(s) (if present) and sections of the tray. Thereby, the wiring may be at least partially encapsulated with an elastomer. The potting material and/or the tray may be constructed from an elastomer such as silicone material. For example, both the potting material and the tray may comprise silicone. It should be appreciated that the potting material may have a different material composition than the tray. In general, the tray and potting material are selected and configured to enable the lighting system to meet with the UL94 5VA test procedure.

In some embodiments, the wiring and/or electrical connector component enters the tray through an inlet port in the tray (e.g., See FIG. 3A). As shown in FIGS. 1B and 3A, inlet port 124 may be formed in a sidewall of the upper section of the tray. It should be understood that the inlet port may be formed in other areas of the tray including the lower section. In these illustrative embodiment, wiring is connected to an electrical connector component 126 which extends through the inlet port. In such embodiments, additional wiring connects to an opposite end of the electrical connector component and may extend directly or indirectly to the AC power source. Areas of the tray surrounding the inlet port may be re-enforced with metal to provide additional support.

In some embodiments, wiring passes from the upper section of the tray through apertures 128 formed in the divider to the lower section of the tray. Once in the lower section of the tray, the wiring may extend along (at least a portion of) the length of the lighting system and may pass through additional apertures 130 formed in the divider to return to the upper section of the tray where the wiring is connected (e.g., by soldering) to bond pad(s) on the circuit board (e.g., See FIG. 3B).

In some embodiments, more than one wire may be assembled in a cable. In some embodiments, the cable may extend from the AC power source to or proximate the inlet port. For example, the cable may extend from the AC power source to an electrical connector component that extends through the inlet port. In some embodiments, cable may not be present within the tray so that the wires are no longer assembled with one another (within a cable) when they are in tray. In such embodiments, the wires may separately extend within various sections with the tray and may be separately connected to separate portions of the circuit board.

In some embodiments, potting material (e.g., silicone) and/or RTV glue may be used to encapsulate wiring and/or other components used in connection with the wiring (e.g., electrical connector component(s)).

It should be understood that other wiring configurations may be used. For example, wiring may enter the tray through an inlet port formed in the lower section and may extend within the lower section until passing through one or more aperture(s) in the divider to enter the upper section where the wiring is connected (e.g., by soldering) to bond pad(s) on the circuit board. In another embodiment, some of the wiring may enter the tray through an inlet port formed in the upper section where that wiring is connected (e.g., by soldering) to bond pad(s) on the circuit board and other wiring may enter the tray through an inlet port formed in the upper section and may pass through one or more aperture(s) in the divider to enter the lower section where such wiring may extend along (at least a portion of) the length of the lighting system and may pass through one or more additional aperture(s) formed in the divider to return to the upper section of the tray where the wiring is connected (e.g., by soldering) to bond pad(s) on the circuit board.

In some embodiments, wiring may be connected within the tray by electrical clips.

In some embodiments, the strip lighting system may include more than one lighting strip segment that are connected to one another to form a longer strip. For example, in som embodiments, a strip lighting system includes a plurality of strip lighting segments 400a. In such embodiments, the segments may be connected to one another using suitable mechanical and/or electrical connection mechanisms. For example, respective segments may be configured to have corresponding engagement features (e.g., on trays) which can cooperate to mechanically connect adjacent segments. Segments may additionally, or separately, be connected using an electrical connector assembly, for example, that joins wiring from one segment to wiring of an adjacent segment.

In some embodiments, the strip lighting system may be designed to be flexible so that the system may be bent during use.

It should be appreciated that the embodiments described herein may be implemented in any of numerous ways. Examples of specific implementations are provided herein for illustrative purposes only. It should be appreciated that these embodiments and the features/capabilities provided may be used individually, all together, or in any combination of two or more, as aspects of the technology described herein are not limited in this respect.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately,” “about,” and “substantially” may be used to mean within ±20% of a target value in some embodiments, within ±10% of a target value in some embodiments, within ±5% of a target value in some embodiments, and yet within ±2% of a target value in some embodiments. The terms “approximately,” “about,” and “substantially” may include the target value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having described above several aspects of at least one embodiment, it is to be appreciated various alterations, modifications, and improvements will readily occur to those skilled in the art. Such alterations, modifications, and improvements are intended to be object of this disclosure. Accordingly, the foregoing description and drawings are by way of example only.

What is claimed is:

1. A strip lighting system, comprising:
a tray;
a circuit board disposed in the tray;
one or more light emitting diodes (LEDs) mounted to the circuit board;
one or more wires electrically connected to the circuit board and disposed at least in part within the tray;
an elastomer in contact with the tray and encapsulating at least part of the circuit board and the one or more wires; and
wherein the strip lighting system is configured to be driven directly or indirectly by an AC power source of at least 60 Volts.

2. The strip lighting system of claim 1, further comprising one or more lenses disposed over the one or more LEDs.

3. The strip lighting system of claim 1, further comprising a connector component electrically connected to the one or more wires.

4. The strip lighting system of claim 1, wherein at least a portion of the connector component is not encapsulated by the elastomer,

5. The strip lighting system of claim 1, wherein the elastomer comprises silicone material.

6. The strip lighting system of claim 1, wherein the tray comprises a divider that separates the tray into an upper section and a lower section.

7. The strip lighting system of claim 1, wherein the circuit board and the one or more LEDs disposed within the upper section of the tray.

8. The strip lighting system of claim 1, wherein the divider comprises a base upon which the circuit board is positioned.

9. The strip lighting system of claim 1, wherein the one or more wires are disposed at least in part within the lower section of the tray.

10. The strip lighting system of claim 1, wherein the one or more wires and/or the connector extend through an inlet port in the tray.

11. The strip lighting system of claim 1, wherein the inlet port is formed in an upper section of the tray.

12. The strip lighting system of claim 1, wherein the one or more wires passes from the upper section of the tray to lower section of the tray via one or more apertures formed in the divider.

13. The strip lighting system of claim 1, comprising more than one strip lighting segment joined together.

14. The strip lighting system of claim 1, wherein the lighting system is directly driven by the AC power source.

15. The strip lighting system of claim 1, wherein the AC power source comprises a wall power socket.

16. The strip lighting system of claim 1, wherein the lighting system is indirectly driven by the AC power source.

17. The strip lighting system of claim 16, wherein the lighting system is driven by an LED driver electrically connected to the AC power source.

18. The strip lighting system of claim 16, wherein the LED driver is configured to convert the AC power to DC power.

19. The strip lighting system of claim 16, wherein the LED driver is a rectifier power supply unit or a high voltage switched mode power supply (SMPS) unit.
